(19) United States
(12) Patent Application Publication
(10) Pub. No.: US 2015/0107041 A1
(43) Pub. Date: Apr. 23, 2015

(54) Cleaning brush for motorcycles

(71) Applicant: Luc Pellerin, Deux Montagnes (CA)

(72) Inventor: Luc Pellerin, Deux Montagnes (CA)

(21) Appl. No.: 14/058,274

(22) Filed: Oct. 20, 2013

(51) Int. Cl. B60S 3/04; A46B 5/00; A46B 11/06; B62J 99/00

(52) U.S. Cl. CPC B60S 3/041; B60S 3/047; B62J 99/00; A46B 5/0079; A46B 11/063; B62J 2099/0066
USPC 15/160

(57) ABSTRACT

An elongated hollow handle member adapted to allow water to pass therethrough; a core member movably attached to a distal end of the hollow handle member, the core member including a nozzle portion having one end pivotably attached to the distal end of the hollow handle member and including a single hole at an opposite end from the one end and adapted to allow the water to be ejected therefrom. A looped wire member attached to an outer surface of the nozzle portion, and a plurality of bristles attached upon a substantial portion of the looped wire member, such that when water is ejected from the nozzle portion it passes into and through the bristles.

This application claims priority based on request GB1218960.1 filed Oct. 22, 2012

### FIELD OF THE INVENTION

The present invention relates generally cleaning implements but more particularly to a cleaning brush for motorcycles.

### BACKGROUND OF THE INVENTION

There exist a variety of cleaning devices and brushes of varying sizes and shapes for a variety of applications. As technology develops, so does the need for a quicker and more efficient way of doing things. Progress brings new devices, machines and inventions that require maintenance in shorter available time. Therefore there is always a need for a more specialized type of cleaning brush; one that reaches and cleans the hard to reach nooks and crannies of certain objects like a motorcycle for example. This inventor has previously filed patent application 20110030156 on Jan. 15, 2010, but certain aspects of which have been found unworkable. This new brush solves those problems

### SUMMARY OF THE INVENTION

In view of the foregoing disadvantages inherent in the known devices now present in the prior art, the present invention, which will be described subsequently in greater detail, is to provide objects and advantages which are:

To provide for a brush designed to scrub and clean hard to reach areas of a motorcycle.

In order to do so, the invention comprises an elongated hollow handle member adapted to allow water to pass therethrough; a core member movably attached to a distal end of the hollow handle member, the core member including a nozzle portion having one end pivotably attached to the distal end of the hollow handle member and including a single hole at an opposite end from the one end and adapted to allow the water to be ejected therefrom. A looped wire member attached to an outer surface of the nozzle portion, and a plurality of bristles attached upon a substantial portion of the looped wire member, such that when water is ejected from the nozzle portion it passes into and through the bristles.

A hose connector removably connected to an opposite end from the distal end of the hollow handle member and is adapted to removably connect to a hose member, thereby allowing the water to pass from the hose member therethrough and into the hollow handle member. The hose connector including a water control valve adapted to control the amount of water allowed to pass therethrough, such that water can pass through the hose connector, the hollow handle member, the nozzle member, and the bristles allowing the brush to be used to clean a motorcycle in a continuous and effective manner.

The nozzle portion is pivotably attached to the distal end of the hollow handle member by an axial joint, wherein the axial joint is adapted to pivot 180 degrees around one axis.

The looped wire is formed from a metallic material that is covered by a plastic material.

The opposite end of the hollow handle member further includes a hook member thereon to hook the brush.

The connection between the hollow handle member and the hose connector is formed as a snapping quick connection.

In another embodiment, the core can be extensible by way of a telescopic arm that is extended and retracted. The brush can be used to clean machinery, equipment and other hard to reach areas besides motorcycles. A hot, warm or cold fluid, soap or oil can be passed through it to clean, foam or lubricate various equipment as desired.

The brush is used in combination with a hose and a motorcycle.

In the original invention, the brush was equipped with a plastic pipe with drilled holes to eject water and fixed bristles. This was found a challenge to manufacture This instant application is equipped with a metal wire embedded in plastic and a single nozzle shooting water into and through the bristles.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be made to the accompanying drawings and descriptive matter which contains illustrated preferred embodiments of the invention.

### BRIEF DESCRIPTION OF THE DRAWINGS

FIG. 1 Top view of the invention and its movement.

FIG. 2 Cutaway side view of a brush of the prior art.

FIG. 3 Cutaway side view of the invention.

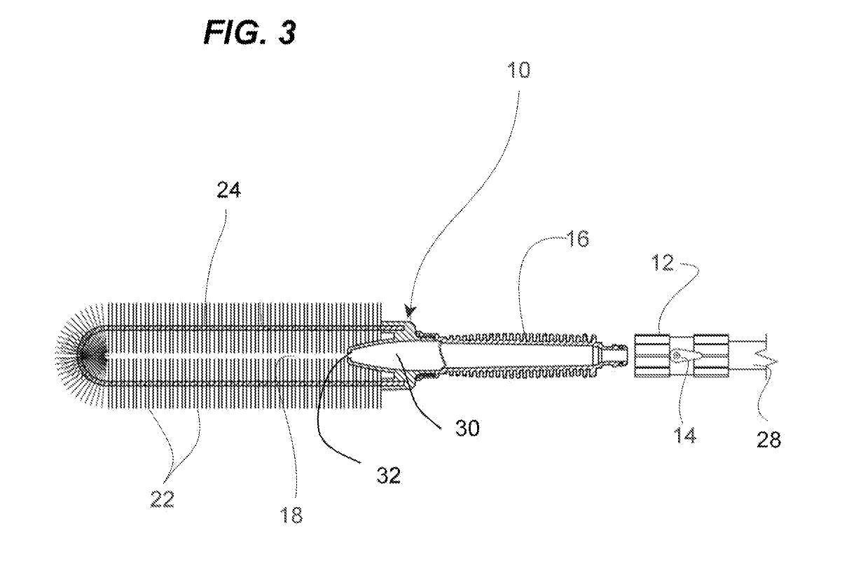

FIG. 4 Side view of the brush and its container attached to a motorcycle.

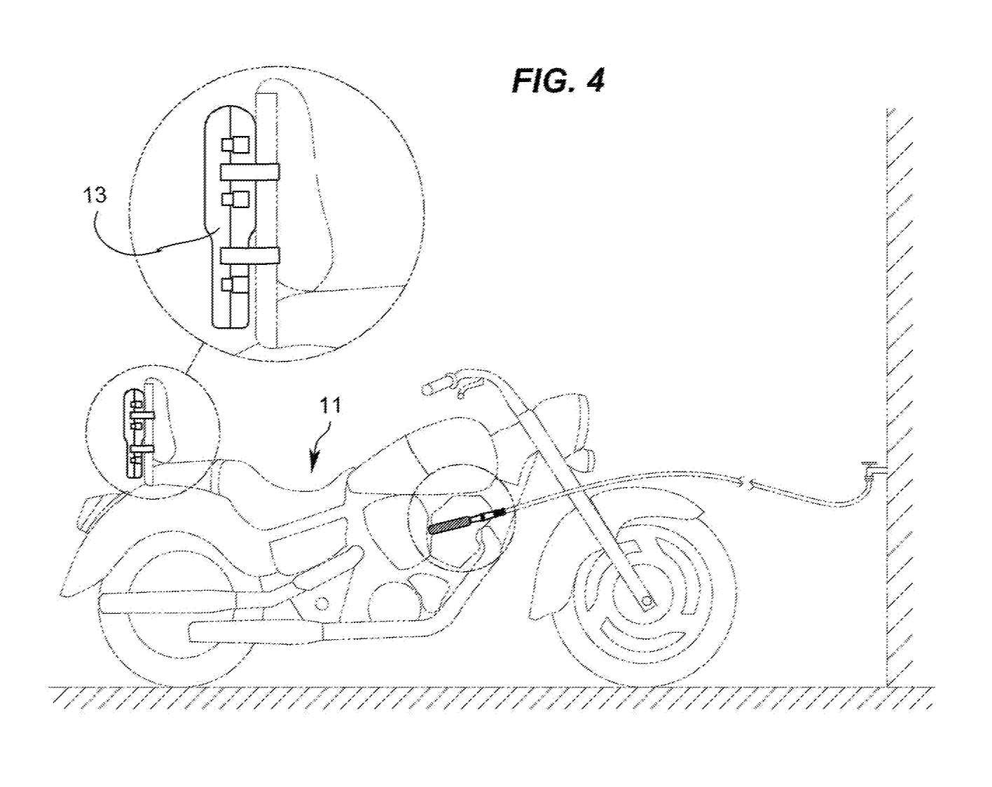

### DETAILED DESCRIPTION OF THE PREFERRED EMBODIMENT

A cleaning brush (10) for use on a motorcycle (11) has a detachable hose connector (12), a water control valve (14), an elongated hollow handle member (16) provided with a hook (26), a looped wire member (24) embedded in plastic and a single nozzle portion (30) extending integrally from the handle member (16) and having a single hole (32) at its extremity ejecting water into and through the bristles (22) attached and extend from the looped wire member (24). The hook (26) is simply a convenient element to hang the brush (10) with.

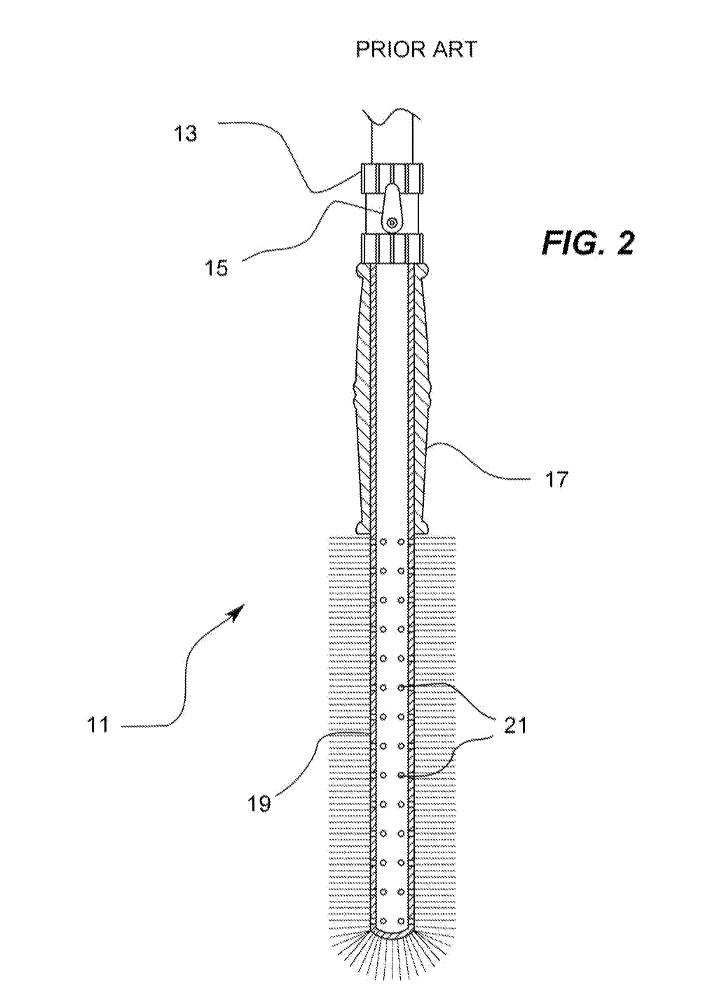

As can be seen in FIG. 2 which represents this inventor's prior art, a cleaning brush of the prior art (11) has a hose connector (13), a water shut off knob (15), a handle (17), a core member (19) through which water passes and a plurality of holes (21) along the core member (19) so that water can exit.

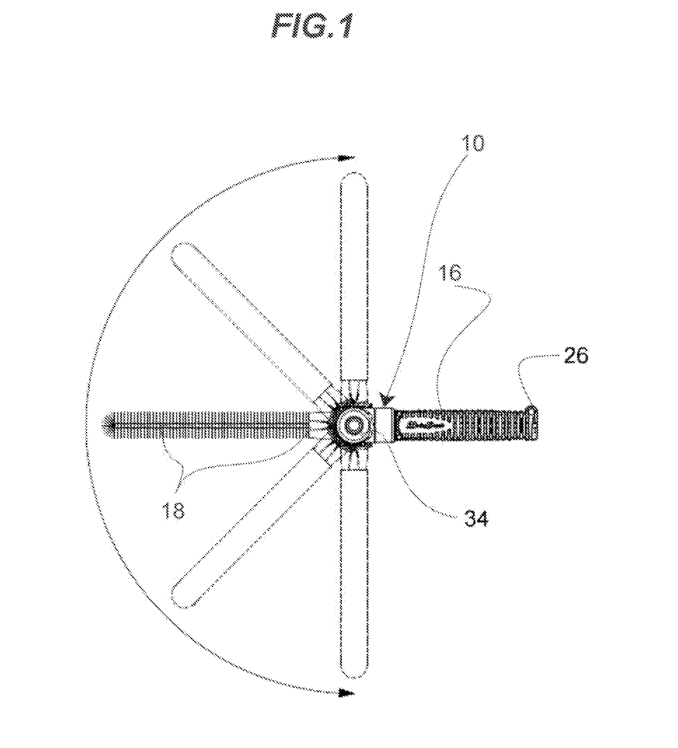

As can be seen in FIG. 1, a core member (18) can swivel about 90 degrees in either direction on one axis about an axial joint (34) on the handle (16) to reach tight spaces.

The detachable hose connector (12) is affixed to a water hose member (28) at one end and to the handle (16) at the other. The water is allowed to pass through the cleaning brush (10) by turning the control valve (14) on the detachable hose connector (12) and out through the hole (32).

The brush is preferably stored in a container (13) attached to the motorcycle (11)

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A cleaning brush for motorcycles comprising an elongated hollow handle member adapted to allow water to pass therethrough; a core member movably attached to a distal end of said hollow handle member, said core member including a nozzle portion having one end pivotably attached to said distal end of said hollow handle member and including a single hole at an opposite end from said one end and adapted to allow said water to be ejected therefrom, a looped wire member attached to an outer surface of said nozzle portion, and a plurality of bristles attached upon a substantial portion of said looped wire member, such that when water is ejected from said nozzle portion it passes into and through said bristles; a hose connector removably connected to an opposite end from said distal end of said hollow handle member and is adapted to removably connect to a hose member, thereby allowing said water to pass from said hose member therethrough and into said hollow handle member, said hose connector including a water control valve adapted to control the amount of water allowed to pass therethrough, such that water can pass through said hose connector, said hollow handle member, said nozzle member, and said bristles allowing the brush to be used to clean a motorcycle in a continuous and effective manner.

2. The cleaning brush of claim 1, wherein said nozzle portion is pivotably attached to said distal end of said hollow handle member by an axial joint, wherein said axial joint is adapted to pivot 180 degrees around one axis.

3. The cleaning brush of claim 1, wherein said looped wire is formed from a metallic material that is covered by a plastic material.

4. The cleaning brush of claim 1, wherein said opposite end of said hollow handle member further includes a hook member thereon to hook said brush.

5. The cleaning brush of claim 1, wherein said connection between said hollow handle member and said hose connector is formed as a snapping quick connection.

6. A combination of a hose member and a cleaning brush for motorcycles, said combination comprising and elongated hose member; and an elongated hollow handle member adapted to allow water to pass from said hose member therethrough; a core member movably attached to a distal end of said hollow handle member, said core member including a nozzle portion having one end pivotably attached to said distal end of said hollow handle member and including a single hole at an opposite end from said one end and adapted to allow said water to be ejected therefrom, a looped wire member attached to an outer surface of said nozzle portion, and a plurality of bristles attached upon a substantial portion of said looped wire member, such that when water is ejected from said nozzle portion it passes into and through said bristles; a hose connector removably connected to an opposite end from said distal end of said hollow handle member and is adapted to removably connect to said hose member, thereby allowing said water to pass from said hose member therethrough and into said hollow handle member, said hose connector including a water control valve adapted to control the amount of water allowed to pass therethrough, such that water can pass through said hose connector, said hollow handle member, said nozzle member, and said bristles allowing the brush to be used to clean a motorcycle in a continuous and effective manner.

7. The combination of claim 6, wherein said nozzle portion is pivotably attached to said distal end of said hollow handle member by an axial joint, wherein said axial joint is adapted to pivot 180 degrees around one axis.

8. The combination of claim 6, wherein said looped wire is formed from a metallic material that is covered by a plastic material.

9. The combination of claim 6, wherein said opposite end of said hollow handle member further includes a hook member thereon to hook said brush.

10. The combination of claim 6, wherein said connection between said hollow handle member and said hose connector is formed as a snapping quick connection.

11. A combination of a motorcycle and a cleaning brush, said motorcycle including a container member adapted to hold and store said cleaning brush when not in use; said cleaning brush comprising an elongated hollow handle member adapted to allow water to pass therethrough; a core member movably attached to a distal end of said hollow handle member, said core member including a nozzle portion having one end pivotably attached to said distal end of said hollow handle member and including a single hole at an opposite end from said one end and adapted to allow said water to be ejected therefrom, a looped wire member attached to an outer surface of said nozzle portion, and a plurality of bristles attached upon a substantial portion of said looped wire member, such that when water is ejected from said nozzle portion it passes into and through said bristles; a hose connector removably connected to an opposite end from said distal end of said hollow handle member and is adapted to removably connect to said hose member, thereby allowing said water to pass from said hose member therethrough and into said hollow handle member, said hose connector including a water control valve adapted to control the amount of water allowed to pass therethrough, such that water can pass through said hose connector, said hollow handle member, said nozzle member, and said bristles allowing the brush to be used to clean a motorcycle in a continuous and effective manner.

12. The combination of claim 11, wherein said nozzle portion is pivotably attached to said distal end of said hollow handle member by an axial joint, wherein said axial joint is adapted to pivot 180 degrees around one axis.

13. The combination of claim 11, wherein said looped wire is formed from a metallic material that is covered by a plastic material.

14. The combination of claim 11, wherein said opposite end of said hollow handle member further includes a hook member thereon to hook said brush.

15. The combination of claim 11, wherein said connection between said hollow handle member and said hose connector is formed as a snapping quick connection.
